(19) United States
(12) Patent Application Publication
(10) Pub. No.: US 2026/0046602 A1
(43) Pub. Date: Feb. 12, 2026

(54) INTERNATIONAL MOBILE SUBSCRIBER IDENTITY (IMSI) MANAGEMENT SYSTEM

(71) Applicant: Skytell AG, Zug (CH)

(72) Inventor: Felix Vakhovsky, Miami, FL (US)

(73) Assignee: Skytell AG, Zug (CH)

(21) Appl. No.: 18/797,638

(22) Filed: Aug. 8, 2024

(51) Int. Cl. H04W 8/18; H04W 4/50; H04W 8/04

(52) U.S. Cl. CPC H04W 8/18; H04W 4/50; H04W 8/04

(57) ABSTRACT

An International Mobile Subscriber Identity (IMSI) management system (100, 200) includes a subscriber identity module (SIM) or eSIM (102), a smart applet (104) on the SIM or eSIM having a plurality or large set of IMSIs on the SIM or eSIM which provides registration to roaming subscribers, and an IMSI control point (106) that serves as a node to control the service provision to a home network operator by converting a sponsor's IMSIs to a home IMSI of the home network operator in a home network (210).

### CROSS-REFERENCE TO RELATED APPLICATIONS

Not applicable.

### TECHNICAL FIELD

The present disclosure generally relates to mobile subscriber selection systems. More particularly, but not exclusively, the present disclosure relates to apparatus, systems, and methods that enable the automatic selection of IMSIs using subscriber identity modules (SIMs) or eSIMs.

### BACKGROUND

A mobile station international subscriber directory number (MSISDN) identifies a mobile subscriber and is used as a caller identification number when a phone call is placed from the mobile device. When a first user wants to call another mobile device user, the first user dials an MSISDN of the other party.

The MSISDN corresponds with an international mobile subscriber identity (IMSI), which uniquely identifies a subscriber in the telecommunication network. The IMSI information is stored in a subscriber identity module (SIM) or eSIM and does not change.

A single MSISDNs can be sent in this manner via a voice communication network, an short messaging service (SMS) network, a multimedia message service (MMS) network, or almost any other wired or wireless network. SMS and MMS networks are similar, but an SMS network is only capable of sending text whereas an MMS network can send multimedia content such as pictures, video, and audio in addition to text. Using MMS does require additional network infrastructure to process the additional data resulting from transmitting pictures, video and audio and typically requires an internet connection whereas an SMS text message does not. Typically, the internet connection for an MMS message is provided through cellular data networks.

With respect to MSISDNs, it is a technical term sometimes used for the mobile number attached to a SIM card or eSIM in a mobile phone. An MSISDN contains several significant numbers to identify country, destination, and subscriber number. Depending on the country, the MSISDN can generally be broken down like this:

MSISDN=CC+NDC+SN, where CC=Country Code, NDC=National Destination Code and SN=Subscriber Number.

In countries like the USA, an NDC is used to identify a specific region within the country, but some countries do not use an NDC. When sending SMS via SMPP, the number must be provided in full international format in order to deliver to the GSM network correctly. Many usability problems can surround this as a large proportion of mobile subscribers are not aware of specific country codes.

Notwithstanding the above, existing systems fail to provide the automatic selection of sponsors or networks in a manner that is efficient and cost effective for both users and providers.

A glossary follows defining the terms and acronymns used in the industry and herein:
IMSI International Mobile Subscriber Identity.
IMSI Management System Automated innovative technology for managing roaming services.
Smart Applet Applet containing a large set of IMSIs on a single SIM card/eSIM.
IMSI Control Point Node that provides the ability to control the provisioning of services to the Home Network Operator, by converting the sponsors' IMSIs to the Home IMSI.
IMSI Sponsor Operator that has roaming agreements with different countries and leases its IMSIs=IMSI Sponsor Operator=Roaming Partner.
Home Network Operator Operator of the Home Network.
Home IMSI International Mobile Subscriber Identity, belonging to the Home Network Operator.
HLR Home Location Register.
HSS Home Subscriber Server.
STP Signaling Transfer Point (see within Home Network 210 in FIG. 2 and 404 in FIG. 4.
SCP Service Control Point.
GMSC Gateway Mobile Switching Center.
SMSC Short Message Service Center.
DRA Diameter Routing Agent.
MCC Mobile Country Code.
MNC Mobile Network Code.
ELS Event download location status.
PLI Provide Local Information Command.
FPLMN List of prohibited networks on the SIM card/eSIM. The FPLMN list on the SIM card/eSIM indicates to the device which networks it cannot connect to. This reduces the number of failed connection attempts.
Whitelist List of approved networks and routes for roaming or IMSI sponsor in every country.
OTA Over-The-Air-System transmitting data over the air.
Coverage list List of available networks.
Subscription Order List Prioritized list of IMSIs which provide access to the network in the Coverage list.
Send Authentication Information Information request that is needed by the visited network's node to identify the Subscriber. The request specifies the IMSI used for registering in the visited network.

### SUMMARY

In some embodiments, an International Mobile Subscriber Identity (IMSI) management system includes a subscriber identity module (SIM) or eSIM, a smart applet on the SIM or eSIM having a plurality or large set of IMSIs on the SIM or eSIM which provides registration to roaming subscribers, and an IMSI control point that serves as a node to control the service provision to a home network operator by converting a sponsor's IMSIs to a home IMSI of the home network operator.

In some embodiments, the smart applet automatically selects the IMSI with the best signal strength and connection quality.

In some embodiments, a local IMSI is automatically selected for each individual country while the subscriber is roaming.

In some embodiments, the smart applet uses a whitelist of authorized roaming partners that are updated via over-the-air.

In some embodiments, the IMSI control point causes the subscriber to be identified as a subscriber of the Home Network despite the fact that the subscriber is roaming with the sponsor's IMSI.

In some embodiments, the IMSI control point holds correlation information between the IMSIs of any sponsors and subscribers' home IMSIs.

In some embodiments, the smart applet ensures registration at a home network while roaming via IMSI sponsors.

In some embodiments, the applet selects a primary IMSI sponsor and a back-up IMSI sponsor from a subscription order list corresponding to a mobile country code (MCC) of available networks corresponding to a coverage list. In some embodiments, the smart applet analyzes responses to provide location information command (PLI) location requests, event download location status (ELS) events and prohibited network (FPLMN) files updates.

In some embodiments, the IMSI control point ensures conversion of sponsors' IMSIs to the Home ISMI to avoid requiring adding sponsors' IMSIs to the Home Operator's systems including the Home Operators home location register and home subscriber server.

In some embodiments, after the roaming subscriber selects the sponsor's IMSI through the smart applet, the SIM or eSIM initiates a registration process in a visited network by sending authentication information from the IMSI of the corresponding sponsor to the visited network and to the systems of the operator-IMSI Sponsor which converts the corresponding request to the Home Network where the IMSI control point converts the IMSI and sends a request to the HLR which holds information for the subscriber's registration in a visited network.

In some embodiments, a smart applet on a subscriber identity module (SIM) or eSIM includes a plurality or large set of International Mobile Subscriber Identities (IMSIs) which provides registration to roaming subscribers, and a processor on the SIM or eSIM configured to communicate with an IMSI control point at a home network operator that serves as a node to control the service provision to the home network operator by converting a sponsor's IMSIs to a home IMSI of the home network operator while the subscriber is roaming in the area of the home network.

In some embodiments, a method of International Mobile Subscriber Identity (IMSI) management during roaming can include the steps of storing a plurality or a large set of IMSIs on a Subscriber Identity Module (SIM) or eSIM which provides registration to roaming subscribers via a smart applet, and using the smart applet to communicate with an IMSI control point that serves as a node to control a service provision to a home network operator by converting a sponsor's IMSIs to a home IMSI of the home network operator.

### BRIEF DESCRIPTION OF DRAWINGS

The accompanying drawings are incorporated herein and form a part of the specification.

FIG. 1 illustrates a block diagram of an IMSI management system, according to some embodiments.

FIG. 2 illustrates a flow diagram of an IMSI management system in accordance with some of the embodiments.

FIG. 3 illustrates a flow chart for a smart applet in a SIM or eSIM, according to some embodiments.

FIG. 4 depicts a registration flow with sponsored IMSI translation at an IMSI control point according to some embodiments.

In the drawings, like reference numbers generally indicate identical or similar elements. Additionally, generally, the left-most digit(s) of a reference number identifies the drawing in which the reference number first appears.

### DETAILED DESCRIPTION

An automated sponsor selection management system is a developed hardware-software system (hereinafter referred to as “HSS”) or information system (hereinafter referred to as “IS”) which allows a mobile operator to continuously provide its subscribers with high-quality mobile communication services regardless of the subscribers' geographical location (worldwide), and with the most cost-effective inter-operator tariff for the mobile/virtual operator (in the event several roaming sponsors are available).

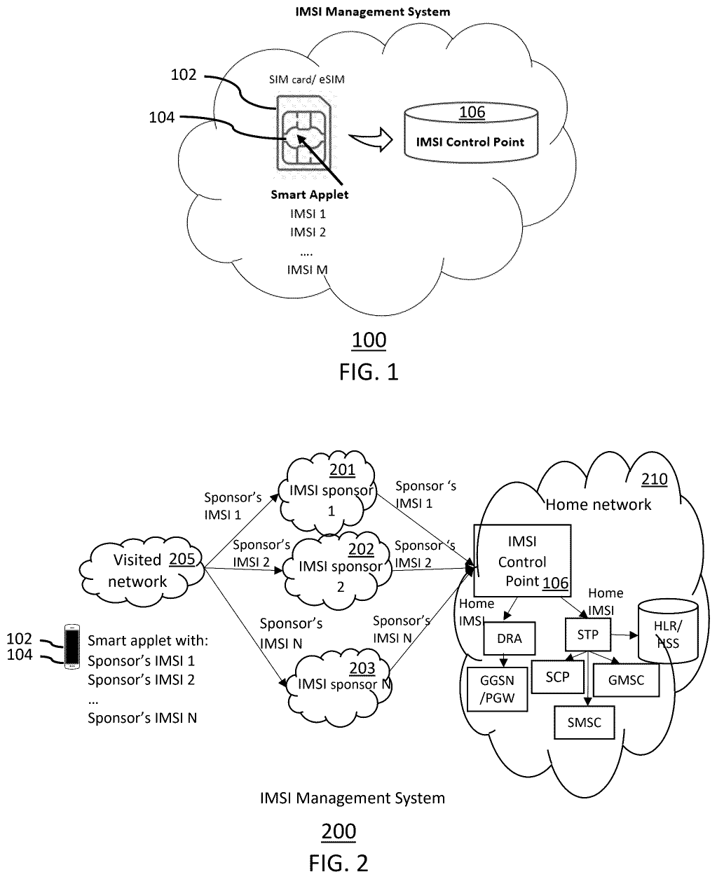

The integrated IMSI Management System 100 as shown in FIG. 1 and its technology is an exclusive solution that provides international roaming services by automatically using the right IMSI with the best signal strength and connection quality based on location, call quality and cost-effective plans. The innovative internal mechanism of the IMSI Management System 100 entails selection of the most cost-effective plans and best roaming coverage on a single SIM card/eSIM.

The purpose of the IMSI Management System technology is automatic management of roaming services using a smart applet 104, which allows switching between a large set of identifiers (IMSIs) on a single SIM card/eSIM 102, as well as automated management of an IMSI Control Point 106, which allows a Home Network Operator to provide its subscribers with quality communication services around the world without having direct roaming contracts.

The internal mechanism of IMSI Management System 100 is a guarantee of uninterrupted global communication, as well as an important tool to ensure financial efficiency, flexibility and convenience not only for communication service providers, but also for consumers.

One of the important functions of a SIM card/eSIM 102, apart from providing communication services, is user identification. The IMSI is a unique subscriber identity (International Mobile Subscriber Identity), stored on the SIM card/eSIM. It holds information about the country and mobile operator associated with it. Usually a classic SIM card/eSIM contains data about one IMSI. Instead, a SIM or eSIM herein will work with multiple IMSIs.

When a SIM card/eSIM user from any mobile operator roams on a different network, the local operator recognizes their IMSI. Communication services are only provided if there is a contractual arrangement with the Home Network Operator, whose information is contained in the IMSI. As a rule, mobile network operators negotiate directly with a partner in each country to provide their Subscribers with roaming services abroad. In doing so, they provide the IMSI range of their Subscribers to the local operator.

The unique IMSI Management System 100 allows avoiding individual roaming agreements with local operators by adding a large set of IMSIs from roaming partners to a single SIM card/eSIM 102. Operators can provide services on other networks by partnering with roaming sponsors who have direct agreements with mobile operators in different countries. Automatic replacement of the Home IMSI with the IMSI of one of the roaming partners and management of several IMSIs simultaneously on one SIM card/eSIM ensures maximum roaming coverage with minimum costs.

The IMSI is managed automatically, and its replacement is absolutely seamless for the Subscriber.

Again and with further reference to the system 200 of FIG. 2, it is necessary to understand that the integrated IMSI Management System 200 includes 2 (two) main components:
1) Smart Applet 104 which is an applet with a large set of IMSIs on one SIM card/eSIM 102, which provides registration to Subscribers while roaming; and
2) IMSI Control Point 106-a node that controls the service provision to the Home Network Operator, by converting the sponsors' IMSIs to the Home IMSI.

The smart applet 104 ensures uninterrupted connectivity as the Smart Applet automatically selects the IMSI with the best signal strength and connection quality. The Subscriber's device in roaming will remain connected even in countries/regions where some roaming networks may be excessively costly or simply unavailable. The smart applet can increase Increased coverage worldwide where there is no need for separate roaming contracts with local carriers. While roaming, a “local” IMSI is automatically selected for each individual country, making the Subscriber's temporary stay “local”. By utilizing local identification, the Operator is able to provide affordable communication, SMS and data even while in international roaming. As a result, the Subscriber can access better plans, at prices lower than the standard rates for voice/SMS/data abroad. The smart applet software, based on Whitelist (list of authorized roaming partners) depending on uploaded prices and destinations from roaming sponsors and through OTA technology (its remote control), allows automatic switching to the appropriate profile depending on the device location.

IMSI management requires a robust control system to ensure a full-fledged roaming network infrastructure. Therefore, it is important to consider the functionality of the IMSI Control Point. Using the IMSI Control Point 106, a Subscriber's identification is in the Home Network 210 by the Home Network IMSI rather than the Sponsor's IMSI (201, 202, or 203). When a Sponsor's IMSI is being converted to the Home IMSI, while establishing connections to Subscribers in the country's Home Network 210, the Subscriber will be identified as the Subscriber of that country and not of the Sponsor Operator's country. Different IMSI Sponsors may be used, they may change, but in the Operator's Home Network 210 the Subscriber will always be identified through his Home IMSI. The identification through the Home IMSI does not require any customization at the Operator's communication nodes, all these tasks are taken care of by the IMSI Control Point 106.

Using the IMSI control point 106, the system authomatically establishes connections in accordance with the rules of the Home Network Operator and therefore compliance with the rules of providing communication in the Operator's Home Network is met. The IMSI Control Point 106 holds information about the correlation between the IMSIs of any sponsors (201, 202, 203, etc.) and Subscribers' Home IMSIs. This enables the Operator to provide mobile communication services in virtually any country according to the rules set by the Home Network Operator, ensuring compliance with applicable legal requirements in the country of the Home Network Operator.

Such a system allows for operational management of a large number of devices and real-time information about their activity. The system 200 also provides seamless integration with the existing infrastructures of mobile network operators as the number of Subscribers and traffic volume increases, which ensures scalability. Additionally, the system 200 provides flexibility of system customization and configuration as well as provision of monitoring, access control systems, automation and optimization of processes.

In summary, the internal mechanism of the IMSI Management System 100 or 200 enables worldwide coverage, autonomous switching between multiple IMSI profiles and switching back and forth as needed to ensure wide coverage, global availability, low costs and the highest quality of service.

The IMSI Management System 200 of FIG. 2 provides an integrated solution including software and hardware designed for management of roaming services in mobile networks. The IMSI Management System 200 is a system that entails utilization of IMSI database and interfaces for interworking with other Operators.

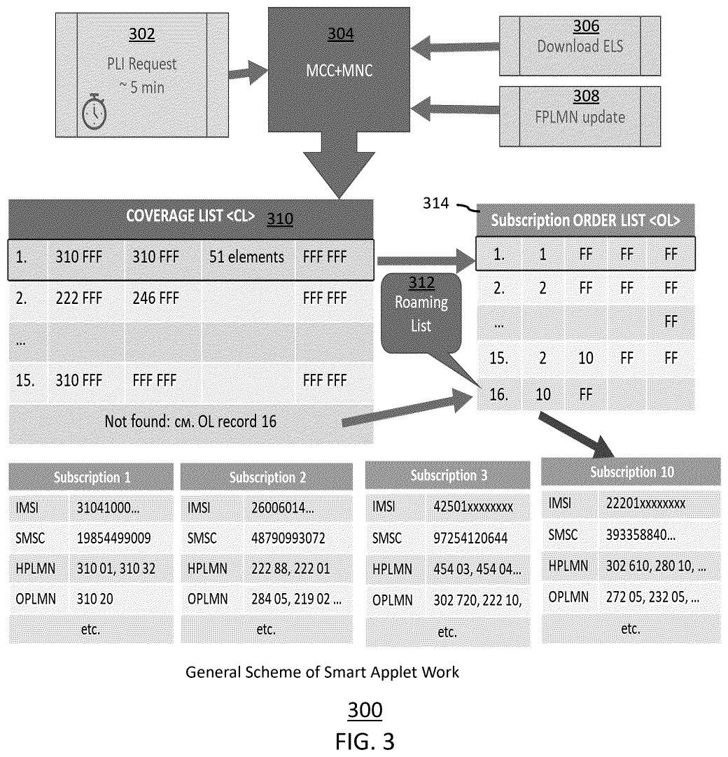

As noted above, the IMSI Management System consists of 2 (two) parts, namely the Smart Applet 104, which ensures registration via IMSI Sponsors and the IMSI Control Point 106, which ensures the conversion of sponsors' IMSIs into the Home IMSI. Operationally, the Smart Applet 104 in the SIM or eSIM provides subscribers with roaming opportunities via IMSI Sponsors. In addition to the primary IMSI, Smart Applet 104 includes IMSIs from additional sponsors. When the subscriber is outside the coverage area, in roaming mode, their mobile device will automatically detect available networks. It will select the primary and back-up IMSI Sponsors from the Subscription Order List (see 314 in FIG. 3) in line with the MCC code of the available network corresponding to the Coverage List 310. To complete this, the Smart Applet 104 carries out analysis of responses to PLI location requests (302), ELS events (306) and FPLMN (308) files updates.

Chart 300 of FIG. 3 depicts the Smart Applet general scheme. In some embodiments, upon arrival to a new country, a mobile device identifies the MCC code of local mobile operators. Primary and back-up sponsors' IMSIs are selected in accordance with this code, as well as prioritized local mobile operators.

Primary sponsor's IMSI is activated for the host country and the waiting time for registration is flexible and can be adjusted to specific circumstances in some embodiments. In some embodiments, if registration doesn't take place, the IMSI of the back-up sponsor is activated. The waiting time for registration is flexible and can be adjusted to specific circumstances. If there is no registration, it switches back to the primary IMSI Sponsor, while if there is no registration, then every time interval (the time interval is again flexible and can be adjusted to specific circumstances), the Applet activates the back-up sponsor's IMSI and switches back to the primary IMSI Sponsor until the network registration is successful.

If there is a connection disruption after successful registration, in some embodiments the back-up sponsor's IMSI is activated in the event there is no registration. The waiting time for registration is flexible and can be adjusted to specific circumstances. If there is no registration, it switches back to the primary IMSI Sponsor, while: if there is no registration, then every time interval (the time interval is flexible and can be adjusted to specific circumstances), the Applet activates the back-up sponsor's IMSI and switches back to the primary IMSI Sponsor until the network registration is successful. During connection to the back-up sponsor's IMSI, every time interval (the time interval is flexible and can be adjusted to specific circumstances) service availability for the primary IMSI Sponsor is being tested.

The IMSI Control Point ensures conversion of sponsors' IMSIs to the Home IMSI. As a result, the Operator's systems (HLR/HSS and others, see 210 in FIG. 2) don't require adding sponsors' IMSIs, they operate in standard mode utilizing a single Home IMSI.

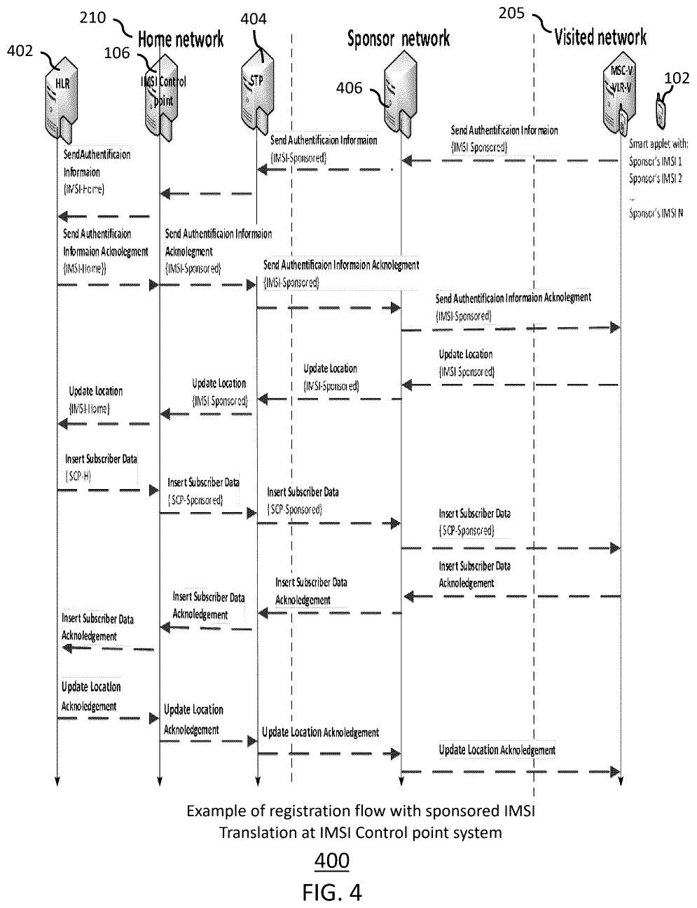

After selecting the sponsor's IMSI through the Applet 104, SIM card/eSIM 102 initiates the registration process in the visited network 205 by sending “Send Authentication Information” from the IMSI of the corresponding sponsor (201, 202, 203, etc) to the visited network and further on to the systems of the Operator-IMSI Sponsor, see flow chart 400 of FIG. 4. Operator-IMSI Sponsor (210) converts the corresponding request to the Home Network where the IMSI Control Point 106 converts the IMSI and sends a request to the HLR 402 which holds the necessary information for the Subscriber's successful registration in the visited network. The HLR 402 acknowledges request receipt. After the acknowledgment, the Subscriber's location is updated. The visited network sends an “Update Location” message from the sponsor's IMSI. This message is received by the Home Network 210 where the IMSI Control Point 106 converts the IMSI and forwards the information to the HLR 402. The HLR 402 converts the data necessary for the registration in the visited network and acknowledges receipt of the Subscriber's location data. The process of registration in the visited network is then complete.

In the absence of any specific clarification related to its express use in a particular context, where the terms “substantial” or “about” in any grammatical form are used as modifiers in the present disclosure and any appended claims (e.g., to modify a structure, a dimension, a measurement, or some other characteristic), it is understood that the characteristic may vary by up to 30 percent. For example, a small cell networking device may be described as being mounted “substantially vertical,” In these cases, a device that is mounted exactly vertical is mounted along a “Y” axis and a “X” axis that is normal (i.e., 90 degrees or at right angle) to a plane or line formed by a “Z” axis. Different from the exact precision of the term, “vertical,” and the use of “substantially” or “about” to modify the characteristic permits a variance of the particular characteristic by up to 30 percent.

The terms “include” and “comprise” as well as derivatives thereof, in all of their syntactic contexts, are to be construed without limitation in an open, inclusive sense, (e.g., “-including, but not limited to”). The term “or,” is inclusive, meaning and/or. The phrases “associated with” and “associated therewith,” as well as derivatives thereof, can be understood as meaning to include, be included within, interconnect with, contain, be contained within, connect to or with, couple to or with, be communicable with, cooperate with, interleave, juxtapose, be proximate to, be bound to or with, have, have a property of, or the like.

Unless the context requires otherwise, throughout the specification and claims which follow, the word “comprise” and variations thereof, such as, “comprises” and “comprising,” are to be construed in an open, inclusive sense, e.g., “including, but not limited to.”

Reference throughout this specification to “one embodiment” or “an embodiment” or “some embodiments” and variations thereof means that a particular feature, structure, or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

As used in this specification and the appended claims, the singular forms “a,” “an,” and “the” include plural referents unless the content and context clearly dictates otherwise. It should also be noted that the conjunctive terms, “and” and “or” are generally employed in the broadest sense to include “and/or” unless the content and context clearly dictates inclusivity or exclusivity as the case may be. In addition, the composition of “and” and “or” when recited herein as “and/or” is intended to encompass an embodiment that includes all of the associated items or ideas and one or more other alternative embodiments that include fewer than all of the associated items or idea.

In the present disclosure, conjunctive lists make use of a comma, which may be known as an Oxford comma, a Harvard comma, a serial comma, or another like term. Such lists are intended to connect words, clauses or sentences such that the thing following the comma is also included in the list.

As the context may require in this disclosure, except as the context may dictate otherwise, the singular shall mean the plural and vice versa. All pronouns shall mean and include the person, entity, firm or corporation to which they relate. Also, the masculine shall mean the feminine and vice versa.

When so arranged as described herein, each computing device may be transformed from a generic and unspecific computing device to a combination device comprising hardware and software configured for a specific and particular purpose. When so arranged as described herein, to the extent that any of the inventive concepts described herein are found by a body of competent adjudication to be subsumed in an abstract idea, the ordered combination of elements and limitations are expressly presented to provide a requisite inventive concept by transforming the abstract idea into a tangible and concrete practical application of that abstract idea.

The headings and abstract provided herein are for convenience only and do not limit or interpret the scope or meaning of the embodiments. The various embodiments described above can be combined to provide further embodiments. Aspects of the embodiments can be modified, if necessary to employ concepts of the various patents, application and publications to provide yet further embodiments.

Based on the teachings contained in this disclosure, it will be apparent to persons skilled in the relevant art(s) how to make and use embodiments of this disclosure using data processing devices, computer systems and/or computer architectures other than that shown in FIG. 4. In particular, embodiments can operate with software, hardware, and/or operating system implementations other than those described herein.

Embodiments of the present disclosure have been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments but should be defined only in accordance with the following claims and their equivalents.

What is claimed:

1. An International Mobile Subscriber Identity (IMSI) management system, comprising:
a subscriber identity module (SIM) or eSIM;
a smart applet on the SIM or eSIM having a plurality or large set of IMSIs on the SIM or eSIM which provides registration to roaming subscribers; and
an IMSI control point that serves as a node to control the service provision to a home network operator by converting a sponsor's IMSIs to a home IMSI of the home network operator.

2. The IMSI management system of claim 1, wherein the smart applet automatically selects the IMSI with the best signal strength and connection quality.

3. The IMSI management system of claim 1, wherein an IMSI is automatically selected for each individual country while the subscriber is roaming.

4. The IMSI management system of claim 1, wherein the smart applet uses a whitelist of authorized roaming partners that are updated via over-the-air.

5. The IMSI management system of claim 1, wherein the IMSI control point causes the subscriber to be identified as a subscriber of the Home Network despite the subscriber roaming with the sponsor's IMSI.

6. The IMSI management system of claim 1, wherein the IMSI control point holds correlation information between the IMSIs of any sponsors and subscribers' home IMSIs.

7. The IMSI management system of claim 1, wherein the smart applet ensures registration at a home network while roaming via IMSI sponsors.

8. The IMSI management system of claim 1, wherein the applet selects a primary IMSI sponsor and a back-up IMSI sponsor from a subscription order list corresponding to a mobile country code (MCC) of available networks corresponding to a coverage list.

9. The IMSI management system of claim 8, wherein the smart applet analyzes responses to provide location information command (PLI) location requests, event download location status (ELS) events and prohibited network (FPLMN) files updates.

10. The IMSI management system of claim 1, wherein the IMSI control point ensures conversion of sponsors' IMSIs to the Home ISMI to avoid requiring adding sponsors' IMSIs to the Home Operator's systems including the Home Operators home location register and home subscriber server.

11. The IMSI management system of claim 1, wherein after the roaming subscriber selects the sponsor's IMSI through the smart applet, the SIM or eSIM initiates a registration process in a visited network by sending authentication information from the IMSI of the corresponding sponsor to the visited network and to the systems of the operator-IMSI Sponsor which converts the corresponding request to the Home Network where the IMSI control point converts the IMSI and sends a request to the HLR which holds information for the subscriber's registration in a visited network.

12. A smart applet on a subscriber identity module (SIM) or eSIM, comprising:
a plurality or large set of International Mobile Subscriber Identities (IMSIs) a on the SIM or eSIM of a subscriber which provides registration to roaming subscribers; and
a processor on the SIM or eSIM configured to communicate with an IMSI control point at a home network operator that serves as a node to control the service provision to the home network operator by converting a sponsor's IMSIs to a home IMSI of the home network operator while the subscriber is roaming.

13. The smart applet of claim 12, wherein the smart applet automatically selects the IMSI with the best signal strength and connection quality.

14. The smart applet of claim 12, wherein the smart applet uses a whitelist of authorized roaming partners that are updated via over-the-air.

15. The smart applet of claim 12, wherein the IMSI control point holds correlation information between the IMSIs of any sponsors and subscribers' home IMSIs.

16. The smart applet of claim 15, wherein the smart applet ensures registration at a home network while roaming via IMSI sponsors.

17. The smart applet of claim 12, wherein the applet selects a primary IMSI sponsor and a back-up IMSI sponsor from a subscription order list corresponding to a mobile country code (MCC) of available networks corresponding to a coverage list.

18. A method of International Mobile Subscriber Identity (IMSI) management during roaming, comprising:
storing a plurality or a large set of IMSIs on a Subscriber Identity Module (SIM) or eSIM which provides registration to roaming subscribers via a smart applet; and
using the smart applet to communicate with an IMSI control point that serves as a node to control a service provision to a home network operator by converting a sponsor's IMSIs to a home IMSI of the home network operator.

19. The smart applet of claim 18, wherein the smart applet automatically selects the IMSI with the best signal strength and connection quality.

20. The smart applet of claim 18, wherein the smart applet uses a whitelist of authorized roaming partners that are updated via over-the-air.
